(19) United States
(12) Patent Application Publication
(10) Pub. No.: US 2014/0306954 A1
(43) Pub. Date: Oct. 16, 2014

(54) IMAGE DISPLAY APPARATUS AND METHOD FOR DISPLAYING IMAGE

(71) Applicant: Wistron Corporation, New Taipei City (TW)

(72) Inventor: Meng-Chao Kao, New Taipei City (TW)

(73) Assignee: Wistron Corporation, New Taipei City (TW)

(21) Appl. No.: 14/146,733

(22) Filed: Jan. 3, 2014

(30) Foreign Application Priority Data
Apr. 11, 2013 (TW) 102112873

(51) Int. Cl. G06T 17/00

(52) U.S. Cl. CPC G06T 17/00
USPC 345/420

(57) ABSTRACT

An apparatus and a corresponding method for displaying image are provided. The apparatus includes a physical camera, a display and a processor. The physical camera takes a first image. The processor is coupled to the physical camera and the display. The processor determines a position of a viewer relative to the display according to the first image, determines a position of a virtual camera relative to a three-dimensional (3D) scene model according to the position of the viewer relative to the display, and controls the display to display a second image of the 3D scene model taken by the virtual camera.

### CROSS-REFERENCE TO RELATED APPLICATION

This application claims the priority benefit of Taiwan application serial no. 102112873, filed on Apr. 11, 2013. The entirety of the above-mentioned patent application is hereby incorporated by reference herein and made a part of this specification.

### BACKGROUND

1. Technical Field

The disclosure relates to an image display apparatus and a method for displaying image. Particularly, the disclosure relates to an image display apparatus capable of changing a displayed image according to viewer's position and a method for displaying image.

2. Related Art

Three-dimensional (3D) displays are quickly developed under impetus of various display panels, systems and brand manufactures. A 3D image technique is gradually evolved from anaglyph glasses, polarized glasses and shutter glasses to auto-stereoscopic glasses.

3D vision is not only a static visual sense, and people's head is not stationary, and considering a dynamic stereovision, a multi-view 3D image display technique is developed.

However, the multi-view only has limited multiple viewpoints, and it is not a continuous image between a viewpoint and another, i.e., when a viewer moves his head, a phenomenon of optical illusion similar to frame skipping is probably occurred, such that the 3D effect is not ideal. Moreover, in order to present the effect of multi-view, a frame resolution has to be sacrificed. Take a display panel with resolution of 1920×1080 for example, in order to present four viewpoints, only a resolution of 480×270 is left for each viewpoint.

Another 3D display technique is holography, and the holography has an optimal 3D presenting effect in space, and the phenomenon of discontinuity or optical illusion is not occurred when the viewer moves. However, a photo-shooting technique of the holography is difficult, and since the photo-shooting is not easy, it is difficult for presenting in animation, and is not yet implemented in the consumer market.

### SUMMARY

The disclosure is directed to an image display apparatus and a method for displaying image, in which a camera is used to get a position of a viewer, so as to interactively change image content to achieve a real three-dimensional (3D) effect similar as that of holography. The disclosure provides an optimal 3D presenting effect, and the image display apparatus is suitable for mass production, and is suitable for the consumer market.

The disclosure provides an image display apparatus including a physical camera, a display and a processor. The physical camera takes a first image. The processor is coupled to the physical camera and the display. The processor determines a position of a viewer relative to the display according to the first image, determines a position of a virtual camera relative to a three-dimensional (3D) scene model according to the position of the viewer relative to the display, and controls the display to display a second image of the 3D scene model taken by the virtual camera.

The disclosure provides a method for displaying image, which includes following steps. A first image is taken, a position of a viewer relative to a display is determined according to the first image. A position of a virtual camera relative to a 3D scene model is determined according to the position of the viewer relative to the display, and the display is controlled to display a second image of the 3D scene model taken by the virtual camera.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an image display apparatus according to an embodiment of the disclosure.

FIG. 2 is a flowchart illustrating a method for displaying image according to an embodiment of the disclosure.

FIG. 3 is a schematic diagram of a position of a viewer relative to a display according to an embodiment of the disclosure.

FIG. 4 is a schematic diagram of an image taken by a physical camera according to an embodiment of the disclosure.

FIG. 5 is a schematic diagram of an image display apparatus according to another embodiment of the disclosure.

FIG. 6 is a schematic diagram of an image taken by a physical camera according to another embodiment of the disclosure.

FIG. 7 and FIG. 8 are schematic diagrams of a 3D scene model and a virtual camera according to an embodiment of the disclosure.

FIG. 9 is a schematic diagram of image correction according to an embodiment of the disclosure.

### DETAILED DESCRIPTION OF DISCLOSED EMBODIMENTS

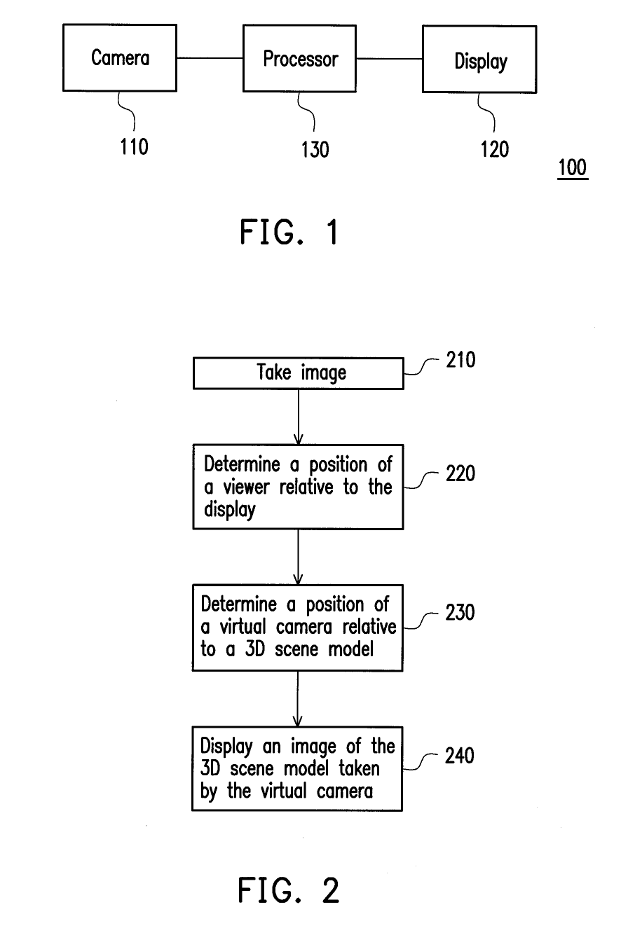

FIG. 1 is a schematic diagram of an image display apparatus 100 according to an embodiment of the disclosure. The image display apparatus 100 includes a camera 110, a display 120 and a processor 130. The processor 130 is coupled to the camera 110 and the display 120. The camera 110, the display 120 and the processor 130 are all physical devices.

FIG. 2 is a flowchart illustrating a method for displaying image according to an embodiment of the disclosure. The method can be executed by the image display apparatus 100. First, in step 210, the camera 110 takes an image. In step 220, the processor 130 determines a position of a viewer relative to the display 120 according to the image taken by the camera 110. The so-called “viewer” is a user viewing the image displayed by the display 120.

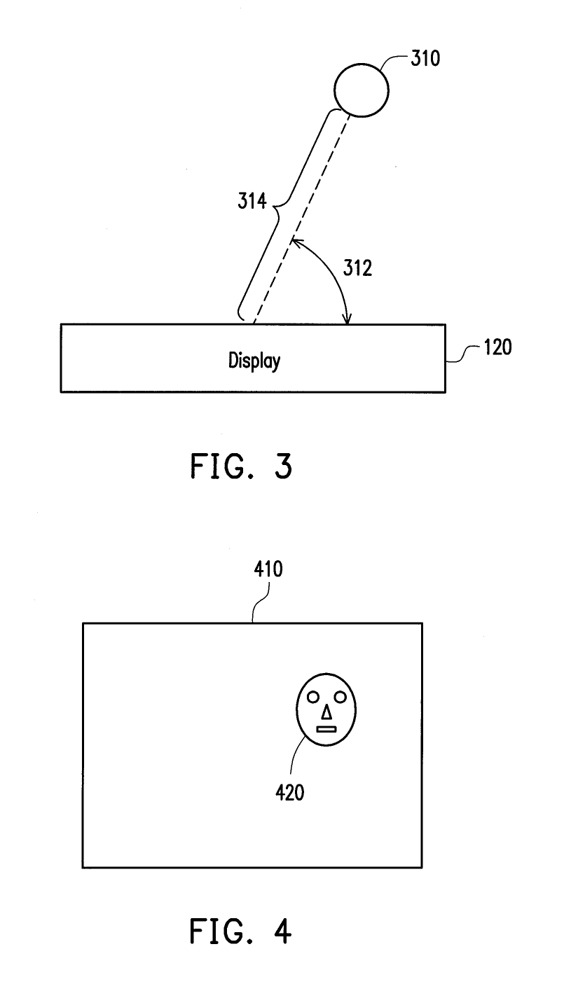

The position of the viewer relative to the display 120 includes an angle and a distance of the viewer relative to the display 120. For example, in a top view diagram of FIG. 3, the angle of a viewer 310 relative to the display 120 is indicated as 312, and the distance of the viewer 310 relative to the display 120 is indicated as 314, which is actually a concept of polar coordinates. In the example of FIG. 3, it is assumed that the viewer only moves in a two-dimensional plane, so that there is only one angle between the viewer 310 and the display 120. If the viewer can freely move in a 3D space, there are two angles between the viewer 310 and the display 120, which respectively correspond to two coordinate axes.

The processor 130 can identify a target object that moves together with the viewer 310 in the image taken by the camera 110, so as to determine the position of the viewer 310 relative to the display 120. For example, in an example of FIG. 4, the target object 420 is the viewer's face, and the processor 130 can determine the angle of the viewer 310 relative to the display 120 according to the position of the target object 420 in an image 410 taken by the camera 110, and can also determine the distance of the viewer 310 relative to the display 120 according to a size of the target object 410 in the image 410.

Besides the face of the viewer 410, the target object 420 can also be other objects that move together with the viewer 310, for example, a general pair of glasses, a pair of 3D glasses used for viewing 3D images, clothes of the viewer, or a human figure of the viewer, etc.

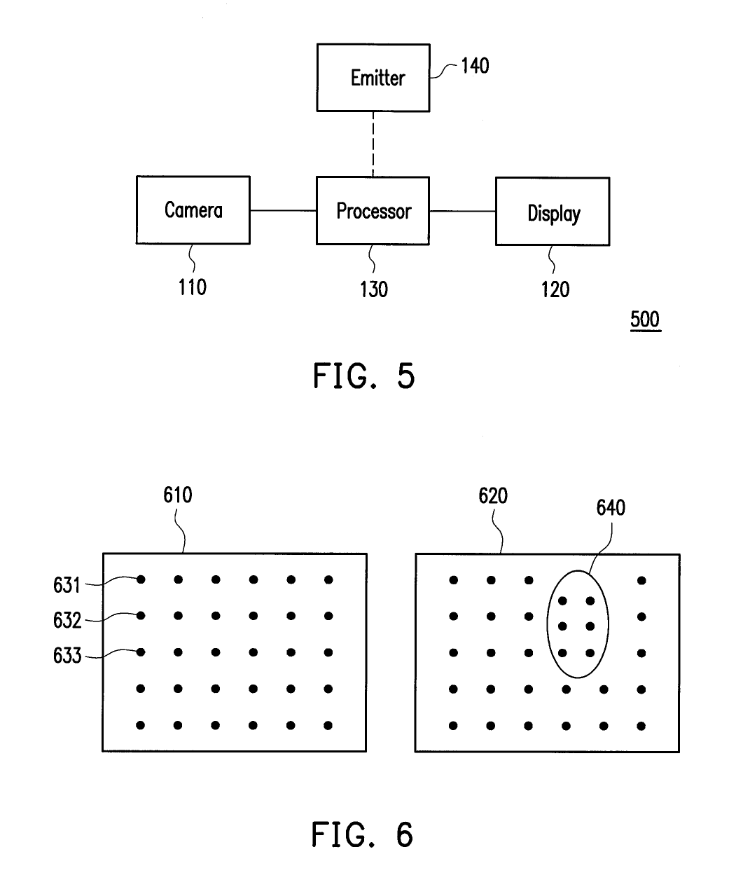

Besides identifying the target object 420 in the image 410, the processor 130 can also determine the position of the viewer through reflected light spots of infrared. Referring to an image display apparatus of FIG. 5, compared to the image display apparatus 100, the image display apparatus 500 further includes an emitter 140, and the camera 110 of the image display apparatus 500 is an infrared camera. The emitter 140 can emit infrared, and the infrared is reflected by ambient environment to cause a plurality of reflected light spots in the image taken by the camera 110. For example, an image 610 taken by the camera has 30 reflected light spots as that shown in FIG. 6, in which three reflected light spots are respectively indicated as 631-633.

The emitter 140 can emit the infrared under control of the processor 130, or can automatically emit the infrared without being controlled by other parts of the image display apparatus 500. If the emitter 140 is controlled by the processor 130, the emitter 140 is required to be coupled to the processor 130, and if the emitter 140 automatically emits the infrared, the emitter 140 is unnecessary to be coupled to the processor 130.

The image 610 taken by the camera 110 does not contain the viewer, and another image 620 taken by the camera 110 includes the viewer 640. The body of the viewer 640 intercepts the infrared to cause a variation of at least one of position, density and brightness of the reflected light spots. For example, compared to the image 610, the viewer 640 in the image 520 causes variation of 6 reflected light spots. The processor 130 can identify such variation to determine the position of the viewer 640 relative to the display 120. In detail, the processor 130 can determine an angle of the viewer 640 relative to the display 120 according to a position of the variation of the reflected light spots, and determine a distance of the viewer 640 relative to the display 120 according to a density or a brightness of the reflected light spots. The higher the density of the reflected light spots is, the closer the distance of the viewer 640 is, and the higher the brightness of the reflected light spots is, the closer the distance of the viewer 640 is.

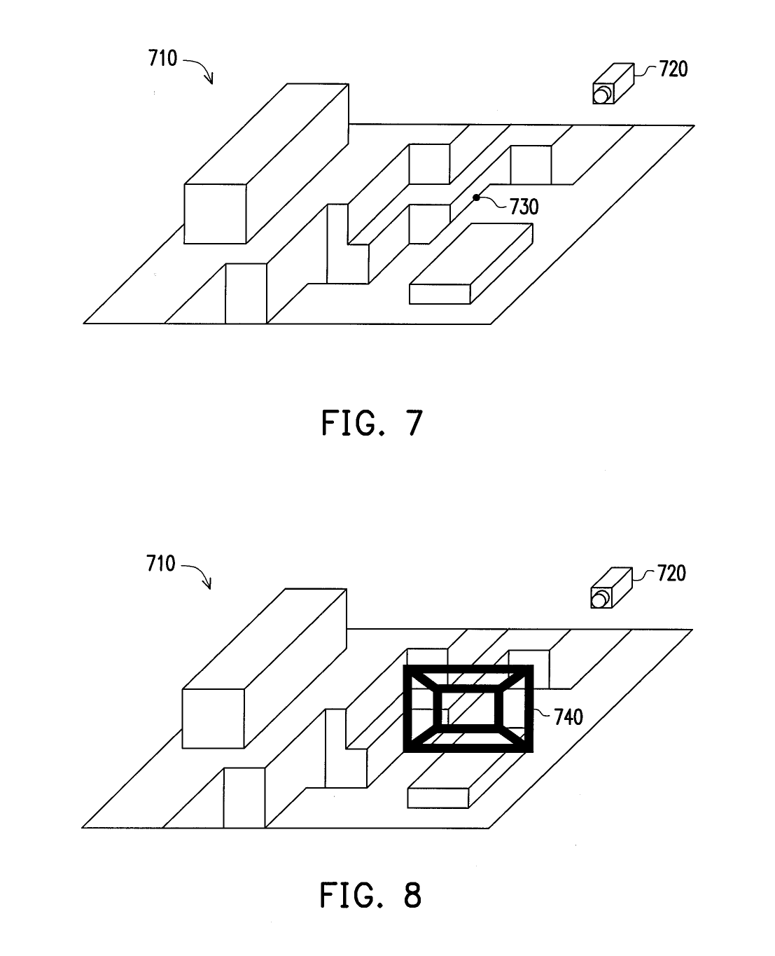

Referring to the method flow of FIG. 2, in step 230, the processor 130 determines a position of a virtual camera relative to a 3D scene model according to the position of the viewer relative to the display 120. The 3D scene model is produced in advance, which can be built in the processor 130 or stored in an external storage device. For example, FIG. 7 is a schematic diagram of a 3D scene model 710 and a virtual camera 720 according to an embodiment of the disclosure. The position of the virtual camera 720 relative to the 3D scene model 710 is a position of the virtual camera 720 relative to a preset position 730 of the 3D scene model 710. The preset position 730 can be fixed, or can be arbitrarily designated by the viewer. The preset position 730 is equivalent to an origin of a polar coordinates system where the virtual camera 720 locates.

The virtual camera 720 is an imaginary camera. The processor 130 can set the position of the virtual camera 720 relative to the 3D scene model 710 to be the same to the position of the viewer relative to the display 120. Therefore, the virtual camera 720 moves synchronously along with the viewer.

Then, referring to the method flow of FIG. 2, in step 240, the processor 130 controls the display 120 to display an image of the 3D scene model 710 taken by the virtual camera 720. The image taken by the virtual camera 720 is generated through calculation of the processor 130 according to the 3D scene model 710 and computer graphics. The virtual camera 720 can be a 2D camera or a 3D camera. If the virtual camera 720 is the 2D camera, the captured image is a conventional 2D image, and the display 120 is a corresponding 2D display to display the 2D image taken by the virtual camera 720. If the virtual camera 720 is the 3D camera, a 3D image can be taken by simulating different images viewed by the left eye and the right eye, and the display 120 is a corresponding 3D display to display the 3D image taken by the virtual camera 720.

To achieve a certain visual effect, a virtual window can be disposed in the 3D scene model to influence the image displayed by the display 120. As shown in FIG. 8, a virtual window 740 is added to the 3D scene module 710, where the virtual window 740 is located at the preset position 730. The processor 130 can control the display 120 to display the image of the 3D scene model 170 taken by the virtual camera 720 through the virtual window 740. The virtual window 740 can limit a field of vision of the virtual camera 720. A window frame of the virtual window 740 can be superposed on the image captured by the virtual camera to achieve a certain visual effect.

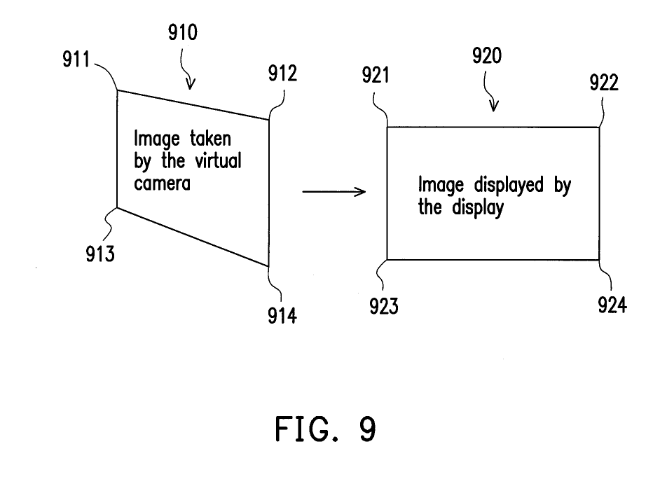

The virtual camera 720 is unnecessary to directly face to the virtual window 740, and the image captured through the virtual window 740 can be skewed, for example, an image 910 shown in FIG. 9. To achieve effects of reality and aesthetic, a sub step of image correction can be added to the step 240. Namely, the processor 130 can correct the image 910 into an image 920 with a shape the same with that on the display 120, and controls the display 120 to display the image 920. The processor 130 can respectively associate endpoints 911-914 at four corners of the image 910 with endpoints 921-924 at four corners of the image 920, and scale the image 910 according to the above association relationship to obtain the image 920. The commonly used image editing software all have such shape correction function, and details thereof are not repeated.

In summary, the disclosure provides an image display apparatus and a method for displaying image, in which a physical camera is used to get a position of a viewer to synchronously move a virtual camera. In this way, the displayed image is synchronously rotated, zoomed in/out according to variation of the viewing angle and viewing distance, so as to achieve a real 3D effect similar as that of holography through general 2D display or 3D display. The dynamic 3D effect of the disclosure is smooth and continuous without a phenomenon of frame skipping of the multi-view technique. The disclosure provides an optimal 3D presenting effect, and the image display apparatus is suitable for mass production, and is suitable for the consumer market.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. An image display apparatus, comprising:
a physical camera, taking a first image;
a display; and
a processor, coupled to the physical camera and the display, determining a position of a viewer relative to the display according to the first image, determining a position of a virtual camera relative to a three-dimensional (3D) scene model according to the position of the viewer relative to the display, and controlling the display to display a second image of the 3D scene model taken by the virtual camera.

2. The image display apparatus as claimed in claim 1, wherein the processor identifies a target object that moves together with the viewer in the first image, so as to determine the position of the viewer relative to the display.

3. The image display apparatus as claimed in claim 2, wherein the position of the viewer relative to the display comprises at least one angle and at least one distance of the viewer relative to the display, the processor determines the at least one angle according to a position of the target object in the first image, and determines the at least one distance according to a size of the target object in the first image.

4. The image display apparatus as claimed in claim 1, further comprising:
an emitter, emitting an infrared, wherein the physical camera is an infrared camera, the infrared causes a plurality of reflected light spots in the first image, and the processor identifies a variation of the reflected light spots caused by the viewer to determine the position of the viewer relative to the display.

5. The image display apparatus as claimed in claim 4, wherein the position of the viewer relative to the display comprises at least one angle and at least one distance of the viewer relative to the display, the processor determines the at least one angle according to a position of the variation, and determines the at least one distance according to a density and/or brightness of the reflected light spots.

6. The image display apparatus as claimed in claim 1, wherein the position of the virtual camera relative to the 3D scene model is a position of the virtual camera relative to a preset position of the 3D scene model, and the position of the virtual camera relative to the 3D scene model is the same to the position of the viewer relative to the display.

7. The image display apparatus as claimed in claim 6, wherein a virtual window is located at the preset position, and the processor controls the display to display the second image of the 3D scene model taken by the virtual camera through the virtual window.

8. The image display apparatus as claimed in claim 1, wherein the virtual camera is a 2D camera or a 3D camera, when the virtual camera is the 2D camera, the second image is a 2D image and the display is a corresponding 2D display, and when the virtual camera is the 3D camera, the second image is a 3D image and the display is a corresponding 3D display.

9. The image display apparatus as claimed in claim 1, wherein the processor corrects the second image into a shape the same with that of image displayed on the display, and controls the display to display the second image.

10. A method for displaying image, comprising:
taking a first image;
determining a position of a viewer relative to a display according to the first image;
determining a position of a virtual camera relative to a 3D scene model according to the position of the viewer relative to the display; and
controlling the display to display a second image of the 3D scene model taken by the virtual camera.

11. The method for displaying image as claimed in claim 10, wherein the step of determining the position of the viewer relative to the display comprises:
identifying a target object that moves together with the viewer in the first image, so as to determine the position of the viewer relative to the display.

12. The method for displaying image as claimed in claim 11, wherein the position of the viewer relative to the display comprises at least one angle and at least one distance of the viewer relative to the display, and the step of determining the position of the viewer relative to the display comprises:
determining the at least one angle according to a position of the target object in the first image; and
determining the at least one distance according to a size of the target object in the first image.

13. The method for displaying image as claimed in claim 10, further comprising:
emitting an infrared, wherein the infrared causes a plurality of reflected light spots in the first image, and the step of determining the position of the viewer relative to the display comprises:
identifying a variation of the reflected light spots caused by the viewer to determine the position of the viewer relative to the display.

14. The method for displaying image as claimed in claim 13, wherein the position of the viewer relative to the display comprises an angle and a distance of the viewer relative to the display, and the step of determining the position of the viewer relative to the display comprises:
determining the angle according to a position of the variation; and
determining the distance according to a density and/or brightness of the reflected light spots.

15. The method for displaying image as claimed in claim 10, wherein the position of the virtual camera relative to the 3D scene model is a position of the virtual camera relative to a preset position of the 3D scene model, and the position of the virtual camera relative to the 3D scene model is the same to the position of the viewer relative to the display.

16. The method for displaying image as claimed in claim 15, wherein a virtual window is located at the preset position, and the step of controlling the display to display the second image comprises:
controlling the display to display the second image of the 3D scene model taken by the virtual camera through the virtual window.

17. The method for displaying image as claimed in claim 10, wherein the virtual camera is a 2D camera or a 3D camera, when the virtual camera is the 2D camera, the second image is a 2D image and the display is a corresponding 2D display, and when the virtual camera is the 3D camera, the second image is a 3D image and the display is a corresponding 3D display.

18. The method for displaying image as claimed in claim 10, wherein the step of controlling the display to display the second image comprises:
correcting the second image into a shape the same with that of image displayed on the display, and controlling the display to display the second image.
